(19) United States
(12) Patent Application Publication
(10) Pub. No.: US 2005/0012280 A1
(43) Pub. Date: Jan. 20, 2005

(54) Sealing member, sealing method and system formed therewith

(75) Inventor: Henry E. Richardson, Washington, MI (US)

Correspondence Address: Scott A. Chapple, Suite 311, 401 South Old Woodward Avenue, Birmingham, MI, 48009, US

(73) Assignee: L&L Products, Inc., Romeo, MI (US)

(21) Appl. No.: 10/918,778

(22) Filed: Aug. 13, 2004

(51) Int. Cl. F16J 15/02

(52) U.S. Cl. 277/628

(57) ABSTRACT

There is disclosed a sealing member. Preferably the sealing member is employed for sealing within a fuel filler assembly although not required.

### FIELD OF THE INVENTION

The present invention relates generally to a member for sealing within an automotive vehicle.

### BACKGROUND OF THE INVENTION

For many years, the transportation industry has been concerned with designing components for providing baffling, sealing, structural reinforcement or the like to automotive vehicles. For example, U.S. Pat. Nos. 5,755,486; 4,901,500; and 4,751,249 describe prior art devices. Generally, the components include expandable materials, which may or may not be combined with other materials for forming seals, baffles, structural reinforcements or the like that fit into one or more cavities of an automotive vehicle. Once the components are placed in the cavities of the vehicle, the expandable materials may be expanded to secure the components in the cavities. However, it can be difficult to desirably position components within a cavity. For example, certain cavities are formed during assembly of the vehicle and may be substantially inaccessible for placement of components therein. Additionally, attachment of components at locations that cavities are expected to form can hinder assembly of the vehicle. Thus, the present invention seeks to provide an assembly for sealing, baffling and/or structurally reinforcing an automotive vehicle wherein the assembly can be more effectively positioned within a cavity of an automotive vehicle.

### SUMMARY OF THE INVENTION

The present invention is directed to a sealing member or gasket. The gasket is typically annular in configuration and includes one or more fasteners. The gasket typically includes or can be entirely formed of an expandable material. Preferably, the gasket is used for sealing within a fuel filler assembly, although not required.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an exemplary sealing gasket in accordance with an aspect of the present invention.

FIG. 2 is a front view of the exemplary gasket of FIG. 1.

FIG. 3 is a perspective view of the exemplary sealing gasket of FIG. 1 applied to an automotive vehicle.

FIG. 4 is a perspective view of an exemplary sealing gasket in accordance with an aspect of the present invention.

FIG. 5 is a front view of the exemplary gasket of FIG. 4.

FIG. 6 is a perspective view of the exemplary sealing gasket of FIG. 4 applied to an automotive vehicle.

FIG. 7 is a perspective view of an exemplary sealing gasket in accordance with an aspect of the present invention.

FIG. 8 is a front view of the exemplary gasket of FIG. 7.

FIG. 9 is a perspective view of the exemplary sealing gasket of FIG. 7 applied to an automotive vehicle.

### DETAILED DESCRIPTION OF THE PREFERRED EMBODIMENT

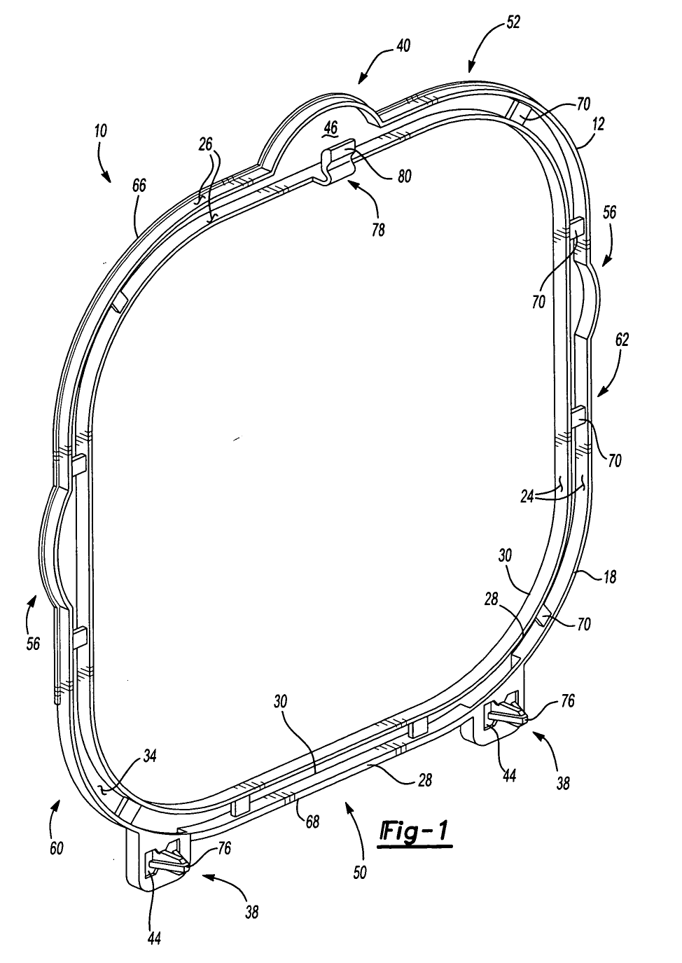

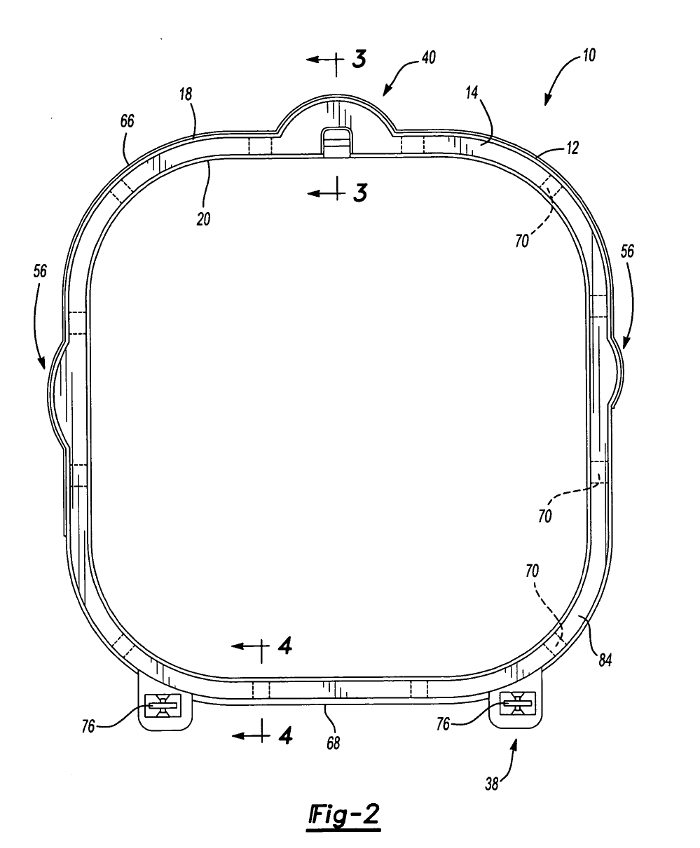

FIGS. 1-3 illustrate an example of a sealing member shown as a sealing gasket 10 in accordance with the present invention. The gasket 10 includes a carrier 12 and an expandable material 14.

The carrier 12 includes a first or outer annular strip 18 and a second or inner annular strip 20. Both the outer annular strip 18 and the inner annular strip 20 have a first or inner annular surface 24 and a second or outer annular surface 26 separated by a thickness of the respective strips 18, 20. Both the outer annular strip 18 and the inner annular strip 20 have a first annular edge 28 opposite a second annular edge 30.

Additionally, in the particular embodiment illustrated, the first annular edge 28 of the inner annular strip 20 is coextensive with the first annular edge 28 of the outer strip 18 and the second annular edge 30 of the inner strip 20 is coextensive with the second annular edge 30 of the outer strip 18. Generally, the gasket 10, the carrier 12 and the strips 18, 20 are shown to have a rectangular or square shape, although a variety of other shapes may be employed unless otherwise specified.

In the particular embodiment illustrated, the inner annular strip 20 and particularly the outer annular surface 26 of the inner annular strip 20 substantially continuously opposes the outer annular strip 18 and particularly the inner annular surface 24 of the outer annular strip 18. In turn, a substantially continuous annular gap 34 is formed between the strips 18, 20.

The carrier 12 also includes a plurality of protrusions. In the embodiment shown, the carrier 12 includes a first protrusion 38, a second protrusion 38 and a third protrusion 40 and each of the protrusions 38, 40 is defined by the outer annular strip 18. As shown, the first and second protrusions 38, are each generally rectangular and each of the first and second protrusions 38 defines an internal cavity 44. As shown, the third protrusion 40 is generally arcuate and also defines an internal cavity 46. Generally, the first and second protrusions 38 are rectangular or square and the third protrusion 40 is arcuate although a variety of other shapes may be employed unless otherwise specified. As shown, the first and second protrusions 38 are located on a side 50 of the gasket 10 opposite a side 52 upon which the third protrusion 40 of the gasket 10 is located.

Optionally, the gasket 10 can also include a pair of smaller protrusions 56, which are located on opposite sides 60, 62 of the gasket 10. As shown, the protrusions 56 are defined in the outer annular strip 18 as being generally arcuate, but may be otherwise shaped.

The gasket 10 can also include one or more lips extending from one or both of the annular strips 18, 20. In FIGS. 1-3, the gasket 10 includes a lip 66 at or adjacent the second side edge 30 of the outer annular strip 18 and extending between the pair of smaller protrusions 56 and over the third protrusion 40. The gasket 10 also includes a lip 68 at or adjacent the first side edge 28 of the outer annular strip 18 and extending between the first and second protrusions 38.

The illustrated gasket 10 also includes a plurality of connectors 70 interconnecting the outer annular strip 18 to the inner annular strip 20. As shown, the connectors 70 extend centrally through the gap 34 between the annular strips 18, 20. Also, as shown, the connectors 70 are located in pairs on opposite sides of the protrusions 38, 40. However, it is contemplated that the connectors 70 may be alternatively located.

The gasket 10 also typically includes a plurality of fasteners such as mechanical fasteners or adhesives. In the embodiment illustrated, the gasket includes a first and second fastener 76 each respectively located adjacent to and extending outwardly from the first and second protrusions 38. Both the first and second fastener 76 are shown as having an arrowhead configuration. The gasket 10 also includes a third fastener 78 extending from the first annular edge 28 of inner annular strip 20 of the carrier 20. The third fastener 78 is adjacent to the arcuate protrusion 40 of the outer annular strip 20 and has a cantilevered flange 80 that is at least partially extending toward the arcuate protrusion 40.

Generally, it is contemplated that the various components of the carrier 12 may be formed separately and attached to each other with fasteners such as mechanical fasteners, adhesives or the like and may be formed of different or same materials. However, it is typically preferred that the components of carrier 12 including the strips 18, 20, the lips 66, 68, the protrusions 38, 40, 56 and the fasteners 76, 80 are integrally shaped or molded of a single material such as a metal or a polymeric material (e.g., nylon, polyamide, polyester, polypropylene, polyethylene or others) which may be filled or unfilled (e.g., filled with glass reinforcement fibers).

The expandable material 14 of the sealing gasket 10 may be located in a variety of locations relative to the carrier 12 and may be adhered or otherwise attached to the carrier 12 and its respective components. Typically, a generally annular portion 84 of the expandable material 14 is disposed in the gap 34 between the inner annular strip 20 and the outer annular strip 18. As shown, the portion 84 is substantially continuous and co-extensive with one or both of the annular strips 18, 20. Also, each of the cavities 44, 46 of the first, second and third protrusions 38, 40, respectively include portions of the expandable material 14 disposed therein.

A variety of expandable materials may be used for the gasket of the present invention. In one embodiment, the material 12 may be formed of a heat activated material and may flow, cure (e.g., be thermosettable), foam or a combination thereof upon exposure to heat. The expandable material may be generally dry to the touch and substantially non-tacky or may be tacky and, in either situation, may be shaped in any form of desired pattern, placement, or thickness, but is preferably of substantially uniform thickness. One exemplary expandable material is L-7102 foam available through L&L Products, Inc. of Romeo, Mich. Another exemplary expandable material is disclosed in U.S. patent application titled “Expandable Material”, Ser. No. 10/867,835, filed on Jun. 15, 2004 and incorporated herein by reference for all purposes.

Though other heat-activated materials are possible, a preferred heat activated material is an expandable polymer or plastic, and preferably one that is foamable. Particularly preferred materials are an epoxy-based, acrylate-based or acetate-based foams, which may be structural, sealing, baffling, acoustic or a combination thereof. For example, and without limitation, the foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based or otherwise based sealing, baffling or acoustic foams are known in the art and may employed in the present invention. A typical foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the structural foam is usually initially processed as a flowable thermoplastic material before curing. It will cross-link upon curing, which makes the material incapable of further flow.

One advantage of the preferred structural foam materials over prior art materials is that the preferred materials can be processed in several ways. The preferred materials can be processed by injection molding, extrusion, compression molding or with a mini-applicator. This enables the formation and creation of part designs that exceed the capability of most prior art materials.

While preferred materials have been disclosed, other materials may be used as well, particularly materials that are heat-activated or otherwise activated by an ambient condition (e.g. moisture, pressure, time, chemical reaction or the like) and cure in a predictable and reliable manner under appropriate conditions for the selected application. Of course, the material may also be formed of non-activatable materials, non-expandable materials or otherwise. Thus, upon activation, the material may soften, cure and expand; soften and cure only; cure only; soften only; or may be non-activatable.

One example of an expandable material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, the desired characteristics of the material include high glass transition temperature (typically greater than 70 degrees Celsius), and adhesion durability properties. In this manner, the material does not generally interfere with the materials systems employed by automobile manufacturers.

Other exemplary expandable materials can include combinations of two or more of the following: epoxy resin, polystyrene, styrene butadiene-styrene (SBS) block copolymer, butadiene acrylo-nitrile rubber, amorphous silica, glass microspheres, azodicarbonamide, urea, dicyandiamide. Examples of such materials are sold under the tradename SIKAELASTOMER, SIKAREINFORCER and SIKABAFFLE and are commercially available from the Sika Corporation, Madison Heights, Mich.

In applications where the material is a heat activated, thermally expanding material, an important consideration involved with the selection and formulation of the material comprising the foam is the temperature at which a material reaction or expansion, and possibly curing, will take place. Typically, the foam becomes reactive at higher processing temperatures, such as those encountered in an automobile assembly plant, when the foam is processed along with the automobile components at elevated temperatures or at higher applied energy levels, e.g., during paint or e-coat baking or curing steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges. Generally, suitable expandable foams have a volumetric range of expansion ranging from approximately 0 to over 1000 percent (e.g., volumetric expansion of greater than 50%, 100%, 200% or 500% of the original unexpanded volume of the material).

The material or medium may be at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) placed along the mold through the use of baffle technology; a die-cast application according to teachings that are well known in the art; pumpable application systems which could include the use of a baffle and bladder system; and sprayable applications.

Formation

As discussed, the expandable material 14 can be processed in a number of different ways. As such, the expandable material 14 may be applied to the carrier 12 using a variety of techniques. In one exemplary preferred embodiment, the carrier 12 is placed as an insert into a mold of an injection molding machine and the expandable material 14 is insert injection molded into place such that it adheres to the carrier 12. In another preferred exemplary embodiment, the gasket 10 is two shot injection molded by injection a first shot of material to form the carrier 12 and injection molding a second shot of material to form and/or apply the expandable material 14 and position the expandable material 14 relative to the carrier 12.

Application

The sealing gasket may be applied to a variety of locations upon a variety of articles of manufacture. It has been found, however, that the sealing gasket is particularly suitable for application and/or sealing adjacent a fuel filler door or fuel filler assembly of an automotive vehicle. For example, the sealing gasket may be located adjacent or at least partially between a fuel filler cup or fuel filler tube and one or both of the rear quarter outer or rear quarter inner panels of an automotive vehicle.

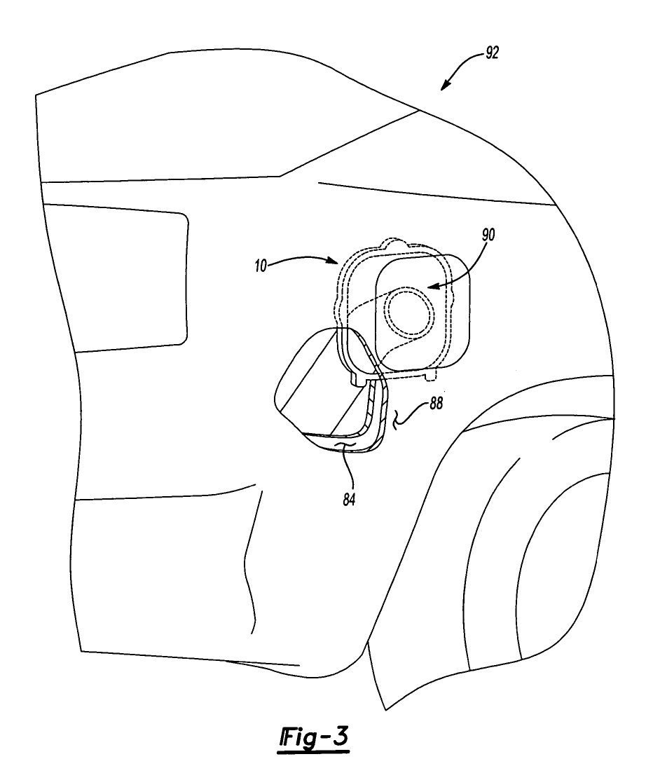

In FIG. 3, the sealing gasket 10 has been located adjacent to a fuel fill assembly and at least partially or substantially entirely between an inner body panel 84 (e.g., a rear wheel house inner panel or rear quarter inner panel) and an outer body panel 88 (e.g., a rear quarter outer panel) of an automotive vehicle 92. Typically, the gasket at least partially or substantially entirely surrounds an opening 90 that leads to the fuel fill assembly. Also, the sealing gasket 10 is typically at least temporarily fastened to the one or both of the rear panels 84, 88 with the fasteners 76, 78 of the gasket 10. In the particular embodiment illustrated, the third or upper fastener 78 is interference fit to an edge of an upper portion of one or both of the rear panels 84, 88 by sliding the flange 80 of the fastener 78 past the edge and the lower or first and second fasteners 76 are interference fit to one or both of the panels 84, 88 by inserting the arrowhead fasteners 76 into openings (e.g., through-holes) in a lower portion of one or both of the rear panels 84, 88.

Upon exposure to heat (e.g., in an e-coat or paint bake oven), the expandable material 14 is activated to flow, expand, cure or any combination thereof such that the material 14 and the gasket 10 seal between the panels 84, 88 for preventing air flow and particularly gas fume flow between the panels 84, 88.

Alternative Embodiment

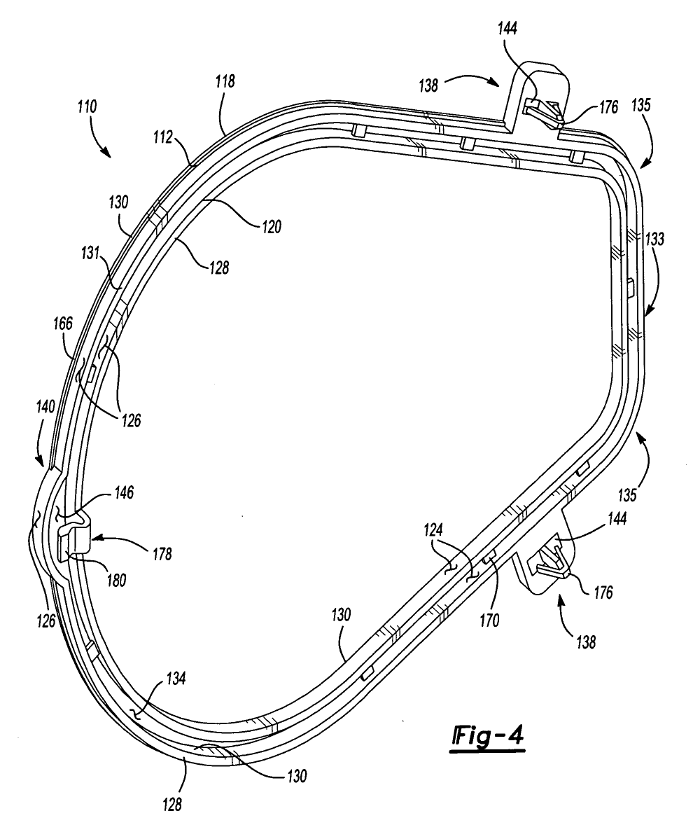

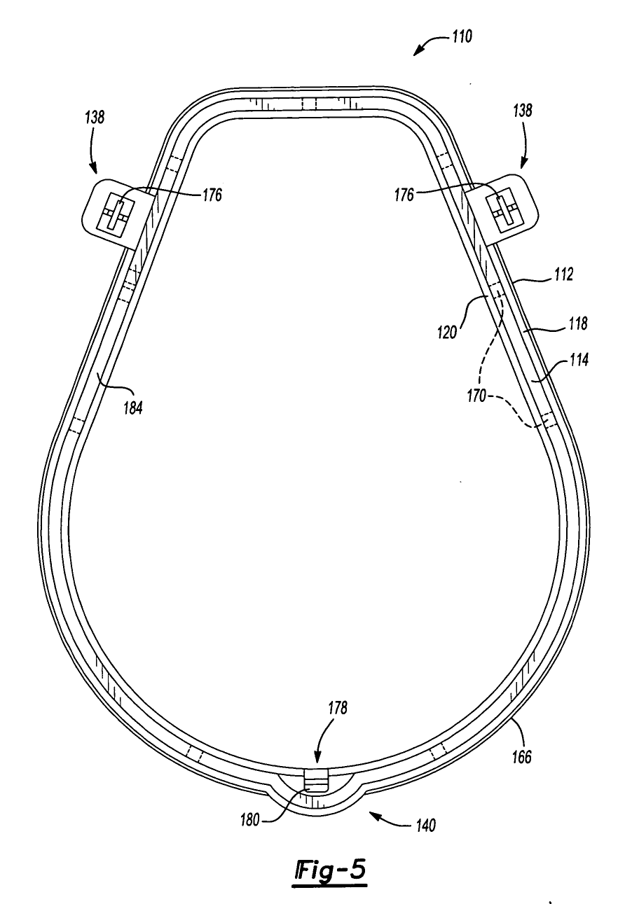

As discussed, the sealing gasket of the present invention may be alternatively designed. As an example, FIGS. 4-6 illustrate one alternative embodiment of an alternative sealing gasket 110 according to the present invention. The gasket 110 includes a carrier 112 and an expandable material 114.

The carrier 112 includes a first or outer annular strip 118 and a second or inner annular strip 120. Both the outer annular strip 118 and the inner annular strip 120 have a first or inner annular surface 124 and a second or outer annular surface 126 separated by a thickness of the respective strips 118, 120. Both the outer annular strip 118 and the inner annular strip 120 have a first annular edge 128 opposite a second annular edge 130.

Additionally, in the particular embodiment illustrated, the first annular edge 128 of the inner annular strip 120 is coextensive with the first annular edge 128 of the outer strip 118 and the second annular edge 130 of the inner strip 120 is coextensive with the second annular edge 130 of the outer strip 118. Generally, the gasket 110, the carrier 112 and the strips 118, 120 are shown to have an arcuate or generally circular portion 131 opposite and connected to a substantially straight side segment 133 that extends between a first corner 135 and a second corner 135. Of course, a variety of other shapes may be employed unless otherwise specified.

In the particular embodiment illustrated, the inner annular strip 120 and particularly the outer annular surface 126 of the inner annular strip 120 substantially continuously opposes the outer annular strip 118 and particularly the inner annular surface 124 of the outer annular strip 118. In turn, a substantially continuous annular gap 134 is formed between the strips 118, 120.

The carrier 112 also includes a plurality of protrusions. In the embodiment shown, the carrier 112 includes a first protrusion 138, a second protrusion 138 and a third protrusion 140 and each of the protrusions 138, 140 is defined by the outer annular strip 120. As shown, the first and second protrusions 138, are each generally rectangular and each of the first and second protrusions 138 defines an internal cavity 144. As shown, the third protrusion 140 is generally arcuate and also defines an internal cavity 146. Generally, the first and second protrusions 138 are rectangular or square and the third protrusion 140 is arcuate, although a variety of other shapes may be employed unless otherwise specified. As shown, the first and second protrusions 138 are respectively located adjacent the corners 135 on opposite sides of the gasket 110 and the third protrusion 140 is centrally located on the arcuate portion 131 of the gasket 110.

The gasket 110 can also include one or more lips extending from one or both of the annular strips 118, 120. In FIGS. 4-6, the gasket 110 includes a lip 166 at or adjacent the second side edge 130 of the outer annular strip 118 and extending substantially continuously about the entire second side edge 130.

The illustrated gasket 110 also includes a plurality of connectors 170 interconnecting the outer annular strip 118 to the inner annular strip 120. As shown, the connectors 170 extend centrally through the gap 134 between the annular strips 118, 120. Also, as shown, the connectors 170 are located in pairs on opposite sides of the protrusions 138, 140. However, it is contemplated that the connectors 170 may be alternatively located.

The gasket 110 also typically includes a plurality of fasteners such as mechanical fasteners or adhesives. In the embodiment illustrated, the gasket includes a first and second fastener 176 each respectively located adjacent to and extending outwardly from the first and second protrusions 138. Both the first and second fastener 176 are shown as having an arrowhead configuration. The gasket 110 also includes a third fastener 178 extending from the first annular edge 128 of inner annular strip 120 of the carrier 112. The third fastener 178 is adjacent to the arcuate protrusion 140 of the outer annular strip 118 and has a cantilevered flange 180 that is at least partially extending toward the arcuate protrusion 140.

Generally, it is contemplated that the various components of the carrier 112 may be formed separately and attached to each other with fasteners such as mechanical fasteners, adhesives or the like and may be formed of different or same materials. However, it is typically preferred that the components of carrier 112 including the strips 118, 120, the lips 166, the protrusions 138, 140 and the fasteners 176, 178 are integrally shaped or molded of a single material such as a metal or polymeric material (e.g., nylon, polyamide, polyester, polypropylene, polyethylene or others) which may be filled or unfilled (e.g., filled with glass reinforcement fibers).

The expandable material 114 of the sealing gasket 110 may be located in a variety of locations relative to the carrier 112 and may be adhered or otherwise attached to the carrier 112 and its respective components. Typically, a generally annular portion 184 of the expandable material 114 is disposed in the gap 134 between the inner annular strip 120 and the outer annular strip 118. As shown, the portion 184 is substantially continuous and co-extensive with one or both of the annular strips 118, 120. Also, each of the annular cavities of the first, second and third protrusions 144, 146, respectively include portions of the expandable material 114 disposed therein. The expandable material 114 of the gasket 110 may be formed of any of the expandable materials discussed above.

As discussed, the expandable material 114 can be processed in a number of different ways. As such, the expandable material 114 may be applied to the carrier 112 using a variety of techniques. In one exemplary preferred embodiment, the carrier 112 is placed as an insert into a mold of an injection molding machine and the expandable material 114 is insert injection molded into place such that it adheres to the carrier 112. In another preferred exemplary embodiment, the gasket 110 is two shot injection molded by injection of a first shot of material to form the carrier 112 and injection molding a second shot of material to form the expandable material 114 and position the expandable material 114 relative to the carrier 112.

The sealing gasket may be applied to a variety of locations upon a variety of articles of manufacture. It has been found, however, that the sealing gasket is particularly suitable for application and/or sealing adjacent a fuel filler door or fuel filler assembly of an automotive vehicle. For example, the sealing gasket may be located adjacent or at least partially between a fuel filler cup or fuel filler tube and one or both of the rear quarter outer or rear quarter inner panels of an automotive vehicle.

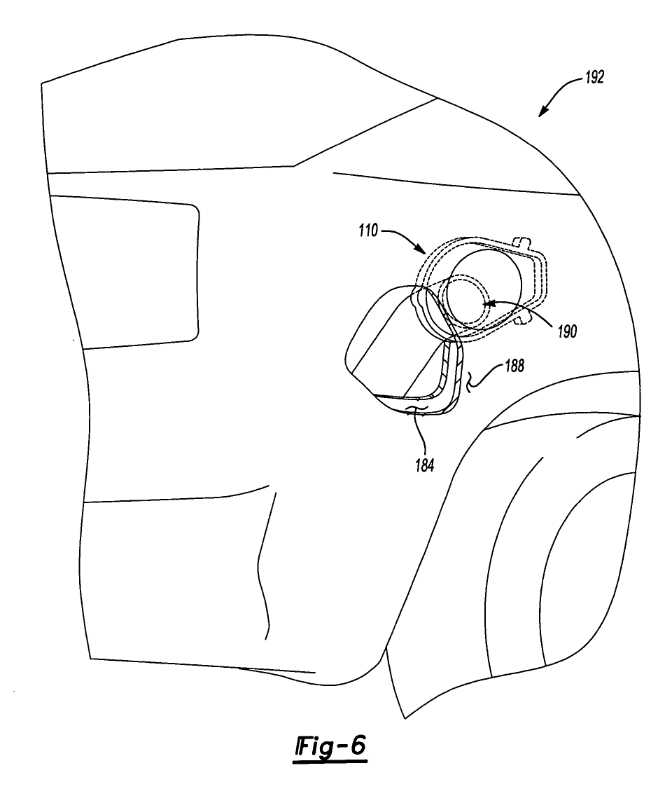

In FIG. 6, the sealing gasket 110 has been located adjacent to a fuel fill assembly and at least partially between an inner body panel 184 (e.g., a rear wheel house inner panel or rear quarter inner panel) and an outer body panel 188 (e.g., a rear quarter outer panel) of an automotive vehicle 192. Typically, the gasket at least partially or substantially entirely surrounds an opening 190 that leads to the fuel fill assembly. Also, the sealing gasket 110 is typically at least temporarily fastened to the one or both of the rear panels 184, 188 with the fasteners 176, 178 of the gasket 110. In the particular embodiment illustrated, the third fastener 178 is interference fit to an edge of a portion of one or both of the rear panels 184, 188 by sliding the flange 180 of the fastener 178 past the edge and the first and second fasteners 176 are interference fit to the panels 184, 188 by inserting the arrowhead fasteners 176 into openings (e.g., through-holes) in a portion of one or both of the rear panels 184, 188 for preventing air flow and particularly gas fume flow between the sealed portions of the panels.

Upon exposure to heat (e.g., in an e-coat or paint bake oven), the expandable material 114 is activated to flow, expand, cure or any combination thereof such that the material 114 and the gasket 110 seal between the rear panels 184, 188.

Alternative Embodiment

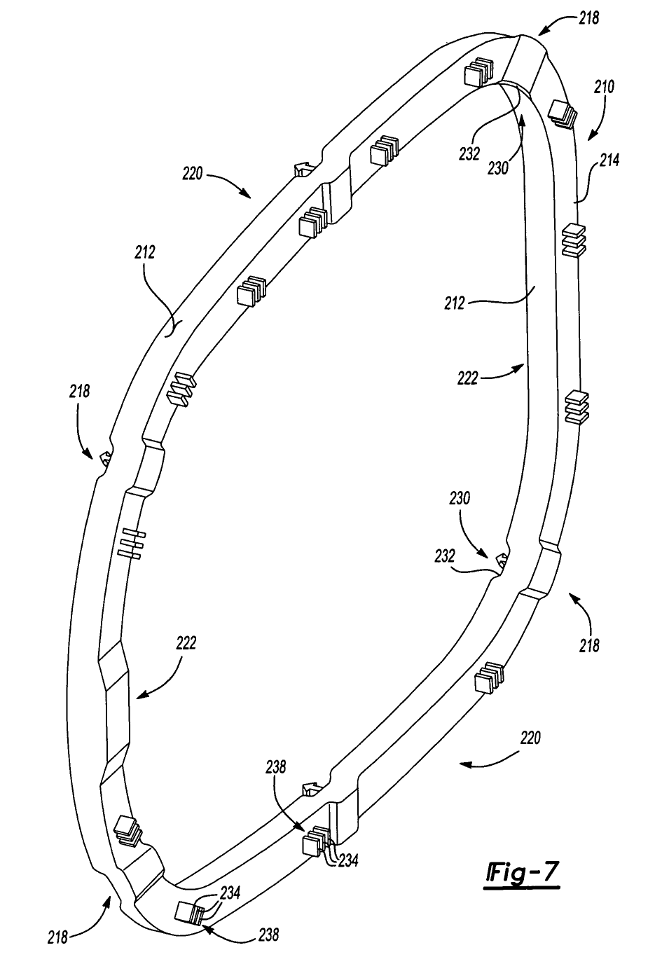

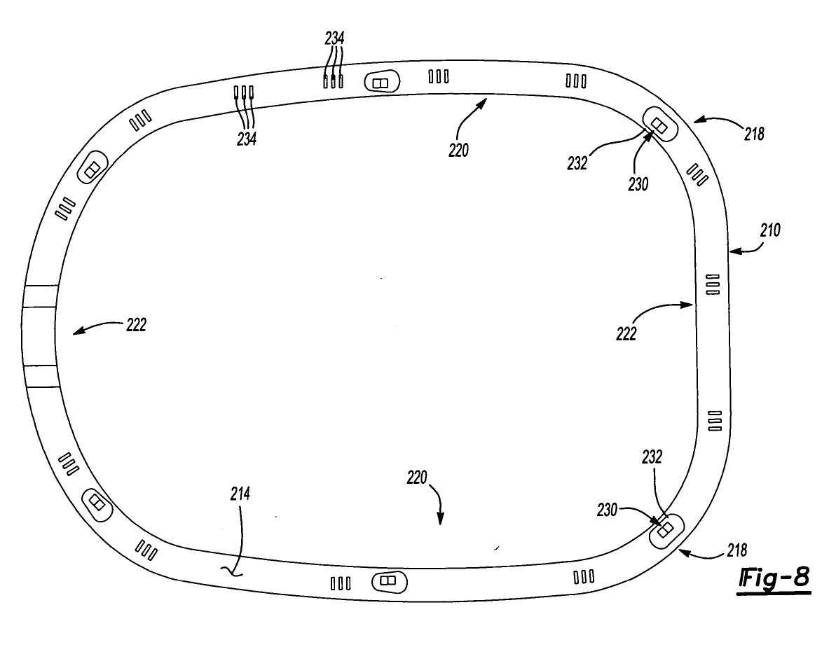

In another embodiment, it is contemplated that a sealing gasket according to the present invention may be formed entirely or substantially entirely of one or more of the expandable materials discussed herein. As and example, FIGS. 7-9 illustrate a gasket 210 formed entirely of expandable material.

It is generally contemplated that the gasket 210 may be shaped in a variety of different configurations unless otherwise specified. As can be seen in the particular embodiment illustrated, the gasket 210 is substantially annular with an arcuate surface 212 opposite a flat surface 214. The gasket 210 is generally rectangular with four rounded corners 218. A pair of first or long segments 220 and a pair of second or short segments 222 extend between the corners 218, the first segments 220 being opposite each other and the second segments 222 being opposite each other.

Typically, the gasket includes one or a plurality of fasteners extending therefrom. In the embodiment shown, six arrowhead fasteners 230 extend from cavities 232 formed in the arcuate surface 212 of the gasket 210. Four of the fasteners 230 are respectively located at or adjacent the four corners 218 of the gasket 210 and two of the fasteners 230 are located centrally upon the first sides 220 of the gasket 210. Preferably, the fasteners 230 are integrally formed of expandable material with the rest of the gasket 210.

The gasket 210 also typically includes one or a plurality of protrusions 234 extending from the gasket 210. In the embodiment illustrated, the gasket 210 includes a plurality (e.g., 10, 11, 12, 13, 14, 15 or more or less) of sets 238 of protrusions 234 and each set 238 includes a plurality (e.g., 2, 3, 4 or more) of protrusions 234. Each of the protrusions 234 extend from the flat or planar surface 214 of the gasket 210.

As discussed, the expandable material can be processed in a number of different ways. As such, the expandable material may be shaped using a variety of techniques. In one exemplary preferred embodiment, the expandable material is injected into a mold of an injection molding machine and the expandable material is injection molded to its desired shape such as the shape of the gasket 210.

The sealing gasket may be applied to a variety of locations upon a variety of articles of manufacture. It has been found, however, that the sealing gasket is particularly suitable for application and/or sealing adjacent a fuel filler door or fuel filler assembly of an automotive vehicle. For example, the sealing gasket may be located adjacent or at least partially between a fuel filler cup or fuel filler tube and one or both of the rear quarter outer or rear quarter inner panels of an automotive vehicle.

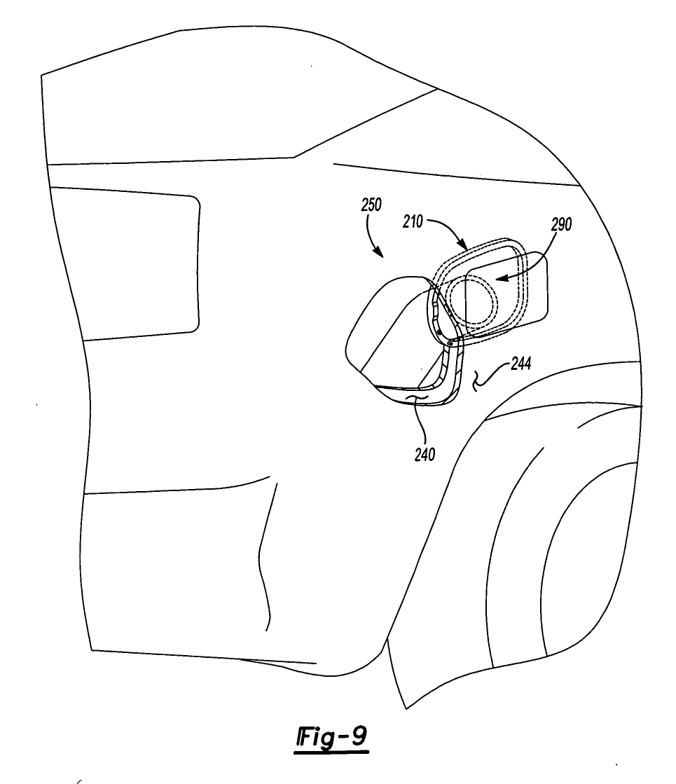

In FIG. 9, the sealing gasket 210 has been located adjacent or at least partially between an inner body panel 240 (e.g., a rear wheel house inner panel or rear quarter inner panel) and an outer body panel 244 (e.g., a rear quarter outer panel) of an automotive vehicle 250. The sealing gasket 210 is typically at least temporarily fastened to the one or both of the rear panels 240, 244 with the fasteners 230 of the gasket 210. Typically, the gasket at least partially or substantially entirely surrounds an opening 290 that leads to the fuel fill assembly. In the particular embodiment illustrated, the fasteners 230 are interference fit to the one or both of the panels 240, 244 by inserting the arrowhead fasteners 230 into openings (e.g., through-holes) of one or both of the rear panels 240, 244.

Upon exposure to heat (e.g., in an e-coat or paint bake oven), the expandable material is activated to flow, expand, cure or any combination thereof such that the material and the gasket 210 seal between the panels 240, 244. Advantageously, the protrusions 234 can contact and can initially whet a surface of one of the panels for assisting the remainder of the gasket in whetting that surface.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A sealing gasket for sealing about a fuel inlet of an automotive vehicle, the gasket comprising:
an expandable material; wherein:
i) the expandable material has a continuous annular configuration;
ii) the expandable material is a heat activated thermosetting material that foams, expands and cure upon exposure to temperature in an e-coat or bake oven; and
iii) the expandable material is generally dry and substantially non-tacky;
a plurality of outwardly extending fasteners, each of the fasteners an arrowhead configuration, each of the fasteners configured for secure placement within openings of a body portion of the vehicle adjacent the fuel inlet and configured for, upon expansion thereof, filling the openings.

2. A sealing gasket as in claim 1 wherein substantially the entire gasket is formed of the expandable material and the annular configuration of the gasket is a continuous closed loop.

3. A sealing gasket as in claim 2 wherein each fastener of the plurality of fasteners is formed of the expandable material.

4. A sealing gasket as in claim 3 wherein the expandable material defines an outer arcuate surface and a planar surface opposite the arcuate surface wherein the outer arcuate surface and the planar surface are substantially coextensive about substantially the entire gasket.

5. A sealing gasket as in claim 4 further comprising a plurality of sets of protrusions space about the gasket, each set of protrusions including a plurality of protrusions, each protrusion being integrally formed of the expandable material.

6. A sealing gasket as in claim 2 further comprising a carrier wherein the carrier include an outer annular strip opposing and substantially coextensive with an inner annular strip and forming a gap there between, the expandable material at least partially located in the gap.

7. A sealing gasket as in claim 6 wherein each of the plurality of fasteners is integrally formed of a plastic material with the carrier.

8. A sealing gasket as in claim 7 wherein each fastener of the plurality of fasteners extends from adjacent a cavity.

9. A sealing gasket as in claim 2 wherein each fastener of the plurality of fasteners extends from adjacent a cavity.

10. A sealing gasket for sealing about a fuel inlet of an automotive vehicle, the gasket comprising:
a carrier member including:
i) an outer annular strip having a first annular edge opposite a second annular edge; and
ii) a first, second and third protrusion, the first, second and third protrusions each defining an internal cavity; and
iii) an inner annular strip substantially continuously opposing the outer annular strip thereby forming a substantially continuous annular gap therebetween; and
iv) a plurality of connectors extending through the gap and interconnecting the outer annular strip to the inner annular strip; and
a first and second fastener each respectively located adjacent to and extending outwardly from the first and second protrusion, both the first and second fastener having an arrowhead configuration;
a third fastener adjacent to the third protrusion of the outer annular strip, the third fastener including a cantilevered flange;
an expandable material adhered to the carrier, wherein:
i) a portion of the expandable material is disposed in the gap between the inner annular strip and the outer annular strip;
ii) a portion of the expandable material is disposed in each of the cavities of the first, second and third protrusions; and
iii) the expandable material is a heat activated thermosetting material that foams, expands and cure upon exposure to temperature in an e-coat or bake oven.

11. A sealing gasket as in claim 10 wherein the gasket includes an arcuate portion connected to a linear portion, the linear portion extending between a first corner and a second corner.

12. A sealing gasket as in claim 11 wherein the first fastener and second fastener are respectively located adjacent the first corner and the second corner.

13. A sealing gasket as in claim 12 wherein the third fastener is centrally located upon the arcuate portion.

14. A sealing gasket as in claim 13 wherein the carrier is substantially entirely formed of a polyamide.

15 A sealing gasket as in claim 14 wherein one of the connectors is located on a first side and one of the connectors is located on a second side of each of the protrusions, the fasteners or both.

16. A sealing gasket for sealing about a fuel inlet of an automotive vehicle, the gasket comprising:
a carrier member including:
i) an outer generally rectangular annular strip having a first annular edge opposite a second annular edge and having a first lip extending outwardly from the first annular edge and a second lip extending outwardly from the second annular edge; and
ii) a first, second and third protrusion, the first and second protrusions each being generally rectangular and each defining an internal cavity, the third protrusion being generally arcuate and defining an internal cavity; and
iii) an inner generally rectangular annular strip substantially continuously opposing the outer annular strip thereby forming a substantially continuous annular gap therebetween, the inner strip having a first annular edge coextensive with the first annular edge of the outer strip, the inner strip having a second annular edge coextensive with the second annular edge of the outer strip; and
iv) a plurality of connectors extending through the gap and interconnecting the outer annular strip to the inner annular strip; and
a first and second fastener each respectively located adjacent to and extending outwardly from the first and second protrusion, both the first and second fastener having an arrowhead configuration;
a third fastener extending from the first annular edge of inner annular strip of the carrier, the third fastener being adjacent to the arcuate protrusion of the outer annular strip and having a flange that is at least partially extending toward the arcuate portion;
an expandable material adhered to the carrier, wherein:
i) a portion of the expandable material is disposed in the gap between the inner annular strip and the outer annular strip;
ii) a portion of the expandable material is disposed in each of the annular cavities of the first, second and third protrusions; and
iii) the expandable material is a heat activated thermosetting material that foams, expands and cure upon exposure to temperature in an e-coat or bake oven; and
iv) the expandable material is generally dry and substantially non-tacky;
wherein the carrier member is substantially entirely composed of nylon.

17. A sealing gasket as in claim 16 wherein one of the connectors is located on a first side and one of the connectors is located on a second side of each of the protrusions, the fasteners or both.

18. A sealing gasket as in claim 17 wherein the sealing gasket is formed by two shot injection molding.

19. A method as in claim 1 wherein the expandable material is activated by exposing the expandable material to an elevated temperature in an e-coat or paint operation.
